(19) United States
(12) Patent Application Publication
(10) Pub. No.: US 2004/0076280 A1
(43) Pub. Date: Apr. 22, 2004

(54) Operation service information mediation system

(75) Inventors: Tanichi Ando, Kawasaki-shi (JP); Masayuki Oyagi, Kyoto-shi (JP)

Correspondence Address: FOLEY AND LARDNER, SUITE 500, 3000 K STREET NW, WASHINGTON, DC, 20007, US

(73) Assignee: OMRON CORPORATION

(21) Appl. No.: 10/617,887

(22) Filed: Jul. 14, 2003

(30) Foreign Application Priority Data
Jul. 17, 2002 (JP) 208893

(51) Int. Cl. H04M 7/00

(52) U.S. Cl. 379/220.01

(57) ABSTRACT

There is provided an operation service information mediation system for sending taxi information or passenger information, which satisfies a desired condition, through a net to a passenger demanding the taxi information or a taxi demanding the passenger information efficiently and without the need for an intermediary individual. The operation service information mediation system includes a group of user terminals possessed by a group of passengers and a group of taxis, respectively, each terminal having a transmission and reception function via a communication network, and an information mediating device of an information mediator for mediating operation service information between the group of passengers and the group of taxis. The information mediating device of the information mediator has an information storage portion, in which taxi information from a group of taxis waiting for passengers, or passenger information from a group of passengers waiting for taxis is stored, an information retrieval portion for retrieving specific taxi information, which satisfies a taxi selection condition received from a specific passenger, or specific passenger information, which satisfies a passenger selection condition received from a specific taxi, among the stored taxi information, or the stored passenger information, and an information distribution portion for distributing the retrieved specific taxi information, or the retrieved specific passenger information to the specific passenger, or the specific taxi via the network.

### CROSS-REFERENCE TO RELATED PATENT APPLICATIONS

Japan Priority Application 208,893/2002, filed Jul. 17, 2002 including the specification, drawings, claims and abstract, is incorporated herein by reference in its entirety.

### BACKGROUND OF THE INVENTION

1. Field of the Invention

The present invention relates to an operation service information mediation system for locating a car, such as a taxi, or the like, which provides a service desired by a passenger, and to introducing the car to the passenger. The present invention, conversely, also relates to locating a passenger desired by a car, such as taxi, and to introducing the passenger to the taxi. That is, the invention relates to an operation service information mediation system enabling a passenger to quickly and surely take a desired taxi, or a taxi to efficiently locate a passenger to enhance car occupancy.

2. Description of the Related Art

Conventionally, for example, when a passenger attempts to find a taxi to take the taxi, techniques have been used, such as looking for an empty taxi running along a road, going to a taxi stand in front of a station, and making reservations through telephone, Internet, or the like. In recent years deregulation relating to taxi enterprises has been occurring and respective taxi companies are developing various new services. However, it is still not possible to instantaneously take a taxi providing a service desired by a passenger. For example, when walking along a street, encountering a taxi depends, in many cases, upon chance, and there is only a small probability of instantly encountering a taxi providing a desired service. Also, often many taxis are on standby at a taxi stand in a crowded place in front of a station, but a passenger, in many cases, cannot freely select a taxi. Further, in the case of reserving a taxi by telephone, it is possible to call a taxi providing a desired service, but it is not possible in this case to instantaneously take a taxi because time is required for a taxi to arrive at a location designated by a passenger after a reservation is made. In particular, when looking for a taxi on the street, it is frequently impossible to take a taxi since a desired taxi may be running in an opposing lane, or a passenger may not be noticed by a taxi driver even when the passenger sees the taxi. Thereby, a passenger may miss an opportunity to take a taxi, and a taxi driver may fail to obtain a passenger, thus causing a disadvantage to both the taxi driver and the passenger.

Also, in the case where a passenger uses a portable telephone or the Internet to communicate with a reception center of a taxi company to reserve a taxi, there is a possibility that a desired taxi is not dispatched. In particular, communication via the telephone does not always afford adequate communication, and in some instances, designation of location and time for dispatching a taxi to a passenger are misheard. In this case an appropriate taxi desired by a passenger is not dispatched to the passenger due to the miscommunication of the taxi company. Also, when a passenger designates a location for taking a taxi, it is difficult to provide a correct oral explanation of the location using road names. A telephone receptionist cannot in many cases understand such an explanation even when the explanation is made.

Problems occur both in the case where a passenger is looking for a taxi and in the case where a taxi is looking for a passenger. For example, take the case where a taxi carries a first passenger to a certain location and the passenger gets off. In order to obtain a subsequent passenger, the taxi typically telephones in, or makes radio contact with a reception center of the taxi company to look for a second passenger who satisfies conditions of the present location, time, and destination of the taxi driver. Current systems involve a possibility that since information is mediated through a person in a reception center of a taxi company, it is not always possible to quickly receive the information and to correctly receive and give the information.

Further, in the case where a passenger uses a portable telephone to communicate with a reception center of a taxi company and a taxi is dispatched to an associated location, the taxi can near the associated location but the taxi and passenger cannot locate each other in some cases. In dispatching a taxi to a location, which is unnamed and difficult to explain, and in a crowded location, it may be difficult for the taxi and passenger to locate each other. Also, even when many taxis park in a taxi stand, it is difficult to locate for a taxi presenting an optimum service to a passenger.

### SUMMARY OF THE INVENTION

According to one embodiment of the invention, the invention solves the conventional inconveniences, and has as an object to provide an operation service information mediation system for sending taxi information or passenger information, which satisfies a desired condition, through a net to a passenger demanding the taxi information or to a taxi demanding the passenger information, efficiently and without the need for an intermediate individual.

According to another embodiment of the invention, the invention has as an object to provide an operation service information mediation system for continuing to retrieve taxi information or passenger information, which satisfies a desired condition, for a predetermined period of time and sending results of the retrieval to a passenger demanding the taxi information, or a taxi demanding the passenger information, via a net.

According to another embodiment of the invention, the invention has an object to provide an operation service information mediation system enabling a passenger who has received mediation information, to visually confirm a pertinent taxi with ease.

One embodiment of the invention provides an operation service information mediation system comprising a group of user terminals possessed by a group of passengers and a group of taxis, respectively, each user terminal having a transmission and reception function via a communication network, and an information mediating device of an information mediator for mediating operation service information between the group of passengers and the group of taxis. The information mediating device of the information mediator comprises an information storage portion, in which taxi information from a group of taxis waiting for passengers, or passenger information from a group of passengers waiting for taxis is stored, an information retrieval portion for retrieving specific taxi information, which satisfies a taxi selection condition received from a specific passenger, or specific passenger information, which satisfies a passenger selection condition received from a specific taxi, among the stored taxi information, or the stored passenger information, and an information distribution portion for distributing the retrieved specific taxi information, or the retrieved specific passenger information to the specific passenger, or the specific taxi, respectively, via the network.

That is, the information mediating device stores information of taxis and passengers to be able to automatically present information of a specific taxi or a passenger, for which both selection conditions meet each other, to the passenger and the taxi, respectively, via a communication net.

The taxi selection condition received from the specific passenger may contain at least one of pick-up location information, car-type information, pick-up time information, presentable service information, and driver's characteristic information, desired by a passenger who waits for a taxi, and when the passenger cannot extract specific taxi information which satisfies the taxi selection condition, the taxi selection condition is stored, as the passenger information, together with information of a contact address designated by the passenger. Also, the passenger selection condition received from the specific taxi may contain at least one of pick-up location information, car-type information, pick-up time information, presentable service information, and driver's characteristic information, and when the taxi cannot extract specific passenger information which satisfies the passenger selection condition, the passenger selection condition is stored, as the taxi information, together with information of a contact address designated by the taxi and information of a present location of the taxi.

Thereby, even in the case where information of the pertinent taxi or passenger is absent at the time of first retrieval, efficient mediation of information is made possible since information of a specific taxi and information of a specific passenger can be sent to the passenger and the taxi at a point of time when new information is input after a lapse of a predetermined time.

The information mediating device of the information mediator may further comprise a timer portion for periodic distribution of the extracted specific taxi information, or the extracted specific passenger information to the group of user terminals possessed by a group of passengers and a group of taxis, respectively. That is, since information can be presented to both a passenger and a taxi periodically, it is possible to determine a state beforehand, in which taxis are crowded, or a number of passengers desire a taxi within a pertinent time range with ease.

The information mediating device of the information mediator may further comprise a charging function for charging an information delivery fee on a specific passenger having received the specific taxi information, or a specific taxi having received the specific passenger information, or both of the passenger and the taxi. Thereby, the information mediator receives an information delivery fee to fund development of new business as an information mediation enterprise.

The information mediating device of the information mediator may further comprise a communication portion, by which both a specific passenger having received the specific taxi information and a specific taxi having received the specific passenger information are enabled to telephone each other via the Internet. That is, since the passenger and the taxi can communicate directly with each other via the Internet through the present system, direct communication can be made more simply and cheaply than ordinary fees of portable telephones, and a location in which the taxi and passenger meet each other, or the like, can be surely confirmed.

Further, a specific taxi having received the passenger information may have a car specifying function for displaying an ID specific to the specific passenger, the car specifying function being configured such that the passenger may visually recognize the ID displayed in the car specifying function, or a predetermined signal is sent to the passenger when the taxi approaches the passenger at a predetermined distance, whereby the passenger can confirm the specific taxi mediated by the information mediating device. Here, the car specifying function comprises, for example, a light sign display board mounted in a front window of a taxi to display an ID, for example, the name of the passenger, specified by the passenger, whereby the passenger can surely confirm the taxi reserved. Also, for example, the passenger may set beforehand a condition for a state, in which the taxi approaches within a predetermined distance, or that passenger wants to be picked-up in 10 minutes, or the like, and when the condition is satisfied, a terminal of the passenger informs the passenger of the taxi approaching by “ringing by an alarm”, making “GPS function ON” since that point of time, “ringing a telephone”, and the like. Thereby, it is possible to prevent the passenger from passing by the taxi, or failing to take the taxi.

According to another embodiment of the invention an information mediating device itself is provided for use with user terminals used by passengers and taxis. The device and the terminals can make use of, for example, portable telephones with GPS function to be used as terminals of the present operation service information mediation system.

Further, according to another embodiment of the invention there is provided an operation service information mediating method of mediating to passengers, operation service information among a group of user terminals, each terminal having a transmission and reception function via a communication network, and the group of user terminals possessed by a group of passengers and a group of taxis. The method comprises the steps of receiving a taxi selection condition from a specific passenger, retrieving specific taxi information, which satisfies the taxi selection condition, from among stored taxi information, and storing the taxi selection condition from the specific passenger as passenger information together with contact address information designated by the passenger when the specific taxi information cannot be extracted from among the stored taxi information, and repeating the retrieval for a predetermined period of time, and distributing results of the retrieval to the specific passenger via the network.

According to another embodiment of the invention there is provided an operation service information mediating method of mediating to taxis, operation service information among a group of user terminals, each user terminal having a transmission and reception function via a communication network, and the group of user terminals possessed by a group of passengers and a group of taxis, comprising the steps of receiving a passenger selection condition from a specific taxi, retrieving specific passenger information, which satisfies the passenger selection condition, from among stored passenger information, and storing the passenger selection condition from the specific taxi as taxi information together with contact address information designated by the taxi when the specific passenger information cannot be extracted from among the stored passenger information, and repeating the retrieval for a predetermined period of time, and distributing results of the retrieval to the specific taxi via the network.

Accordingly, both a passenger and a taxi, respectively, may have access to the database of taxis and passengers in the present operation service information mediation system to be able to readily obtain information, which satisfies a taxi selection condition or a passenger selection condition as desired.

### BRIEF DESCRIPTION OF THE DRAWINGS

FIG. 1 is a conceptional view illustrating a system according to an embodiment of the invention;

FIG. 2 is a schematic view in the case where material for judgment in selecting a taxi is given to a passenger;

FIG. 3 is a block diagram illustrating functions of an embodiment of the functions shown in each invention block;

FIG. 4 is a view illustrating a hardware configuration of an information mediating device according to an embodiment of the invention;

FIG. 5 is a flowchart illustrating operation of an operation service information mediating system according to an embodiment of the invention;

FIGS. 6A, 6B and 6C are flowcharts illustrating operation of the operation service information mediating system according to embodiments of the invention;

FIGS. 7A, 7B, 7C and 7D illustrate a first example of a display screen in the case where a passenger uses a user terminal to retrieve a taxi according to an embodiment of the invention; and

FIGS. 8A, 8B, 8C and 8D illustrate a second example of a display screen in the case where a passenger uses a user terminal to retrieve a taxi according to an embodiment of the invention.

### DESCRIPTION OF THE PREFERRED EMBODIMENTS

The invention will be described in detail below with reference to embodiments shown in the drawings. Dimensions, materials, shapes, and relative positions of constituent parts described in the embodiment are not intended to limit the scope of the invention thereto unless particularly specified, and constitute only an illustrating example.

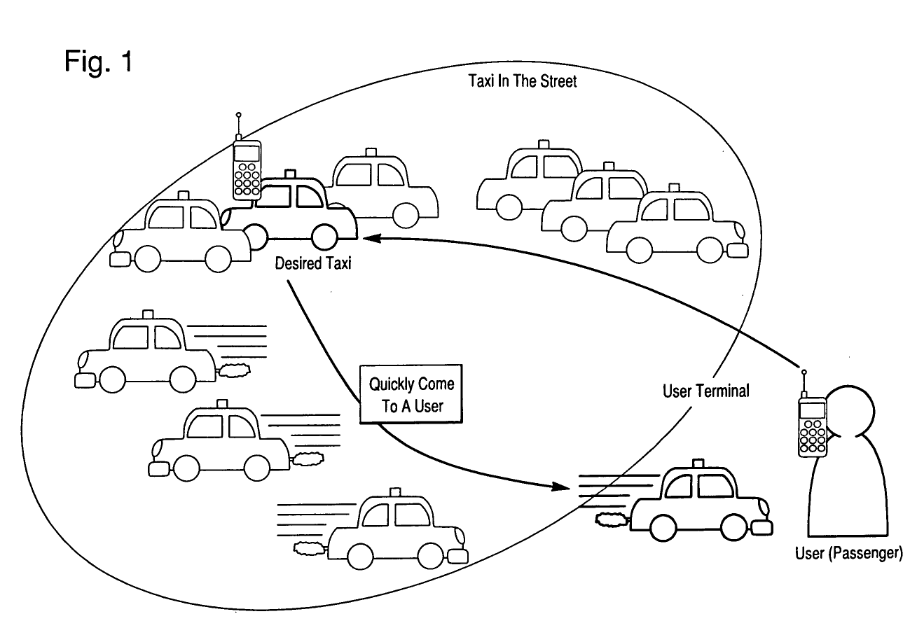

FIG. 1 is a conceptional view illustrating a system according to an embodiment of the invention. The embodiment provides a system permitting a passenger to locate a taxi, which provides a desired service, and to introduce the passenger to the taxi. The embodiment also provides a system permitting a taxi to locate a passenger who requires a desired service, and to introduce the taxi to the passenger. Thereby, a passenger can rapidly and surely take a desired taxi, and a taxi can rapidly and surely acquire a desired passenger. Thus, disadvantages for both the taxi and passenger may be eliminated.

In the case A) where a passenger is looking for a taxi (see FIG. 1), the procedure may comprise: 1) enabling the passenger to make use of a terminal with data communication and talking functions to retrieve a taxi, which provides a desired service, and a desired driver's taxi, thus giving the passenger material for making judgment in choosing a taxi. When the passenger has selected a taxi to be taken, the procedure may comprise: 2) permitting a taxi driver and the passenger to talk directly with each other, thus assisting the passenger to readily meet a taxi, which provides a desired service. Also, not only voice communication but also position detection means, such as GPS (Global Positioning System), for example, may be used to enable a passenger and a taxi to determine the present positions of each other.

Conversely, in the case B) where a taxi is looking for a passenger (not shown), the procedure may comprise: 1) enabling the taxi to make use of a terminal with data communication and talking functions to retrieve a passenger who requires a desired service, thus providing the taxi with material for making a judgment in selecting a passenger. When the taxi has selected a passenger, the procedure may comprise: 2) permitting the taxi driver and the passenger to talk directly with each other, thus assisting the taxi in communication with a passenger who requires a service.

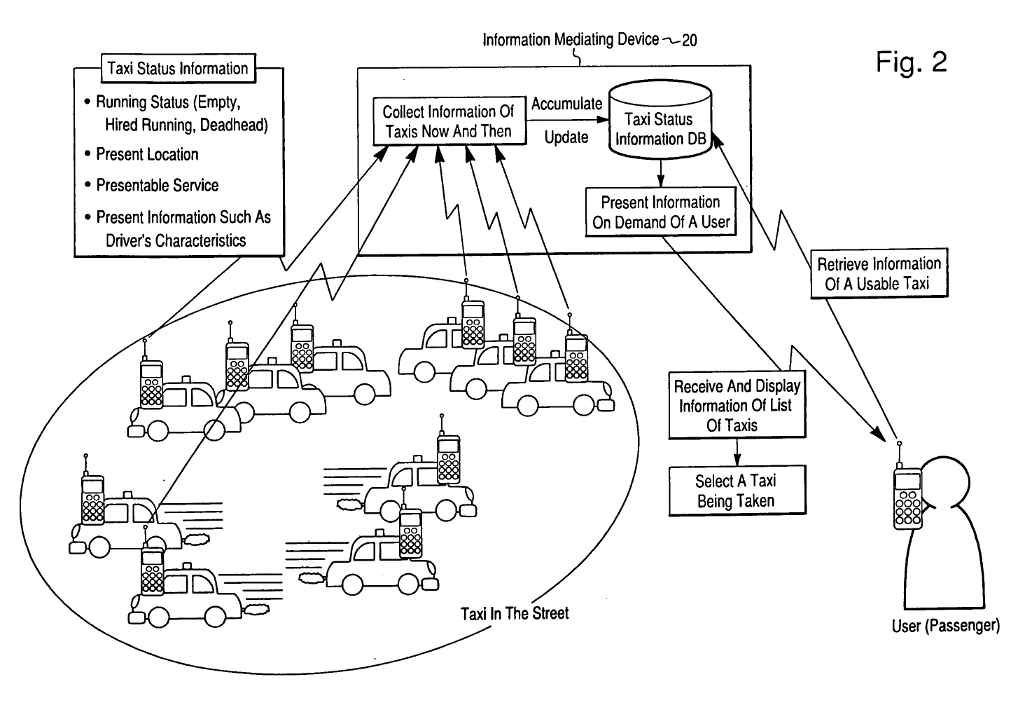

FIG. 2 is a schematic view of the case A), that is, the case where material for making judgment in selecting a taxi is provided to a passenger. For example, a list of corresponding taxis may be displayed with the use of, for example, a portable telephone or PDA (Personal Digital Assistance) possessed by the passenger, and a best one among the taxis may be selected by the passenger. In addition, in the case B), that is, the case where material for making judgment in selecting a passenger is provided to a taxi in contrast with A), a list of corresponding passengers may be displayed (not shown).

1) First, a taxi in the street may periodically send “taxi status information”, such as operation empty, hired running, deadhead, and so on, present location of the taxi, the service presented, or driver's characteristics to “information mediating device” 20. The taxi status information enables a passenger in making judgment in choosing a taxi.

2) The “information mediating device,” having collected information from taxis, accumulates and updates the information in a “taxi status information DB”, and waits for access of the information from a passenger.

3) The information mediating device 20 retrieves status information with respect to serviceable taxis, and presents a list of serviceable taxis to a passenger's terminal.

4) A passenger having received the list may select a taxi to be taken. The passenger may see the list of corresponding taxis displayed on a display surface of, for example, a portable telephone or PDA (Personal Digital Assistance).

FIG. 2 illustrates the case where a passenger performs retrieval and selection as described above. In the case where a taxi (not shown) retrieves and selects a passenger, the information mediating device 20 collects information regarding passengers and periodically accumulates the information in the taxi status information database (DB). In this case, information of passengers on standby because of inconsistency of conditions in retrieval performed by previous passengers is accumulated. A selection condition for a passenger is input into the taxi status information DB from a taxi and a corresponding list of passenger information is sent to the taxi to permit the taxi driver to select a best passenger among the list of passengers.

A description is shown provided of a function allowing a passenger and a taxi to ensure that they meet with each other. A passenger having selected a taxi to be taken from a list of serviceable taxis displayed on a passenger's terminal may make a telephone call directly to the taxi selected. The passenger, to whom the list is sent, may call the number of a portable telephone of a taxi driver or may make a telephone call by means of a relay function of an Internet telephone in the information mediating device according to one embodiment of the invention. The passenger may describe the passenger's appearance by voice communication and the taxi driver may describe the shape, color, and number of the car. Also, not only voice communication but also data communication may be used to send to the other party, data position information of both parties acquired by GPS, or a surrounding scene photographed in motion picture or still picture by means of a CCD (Charge-Coupled Device) camera, thereby ensuring that the parties meet with each other. Also, since the taxi driver drives in many cases while talking on a portable telephone, care may be taken to avoid road traffic violations by making use of a device that imparts an additional function of voice recognition to a portable telephone. This enables voice to achieve an operation of starting and termination of talking.

Further, an embodiment of the invention provides an auxiliary function of allowing a passenger and a taxi to ensure that they meet with each other. The function sets an event as a preliminary condition and performs a notice process such as turning on the power of GPS of a passenger's terminal. A passenger sets beforehand a condition, for example, “when a reserved taxi approaches within a distance of at most 1 km”, “at ten minutes before a reserved time of a taxi”, or the like, and when the condition is satisfied, a passenger's terminal provides a notice of the approach of a taxi by “calling by an alarm”, turning the “GPS function ON” since that point of time, giving “a telephone a ring”, and the like. Thereby, a passenger is prevented from going past a taxi and failing to acquire a taxi.

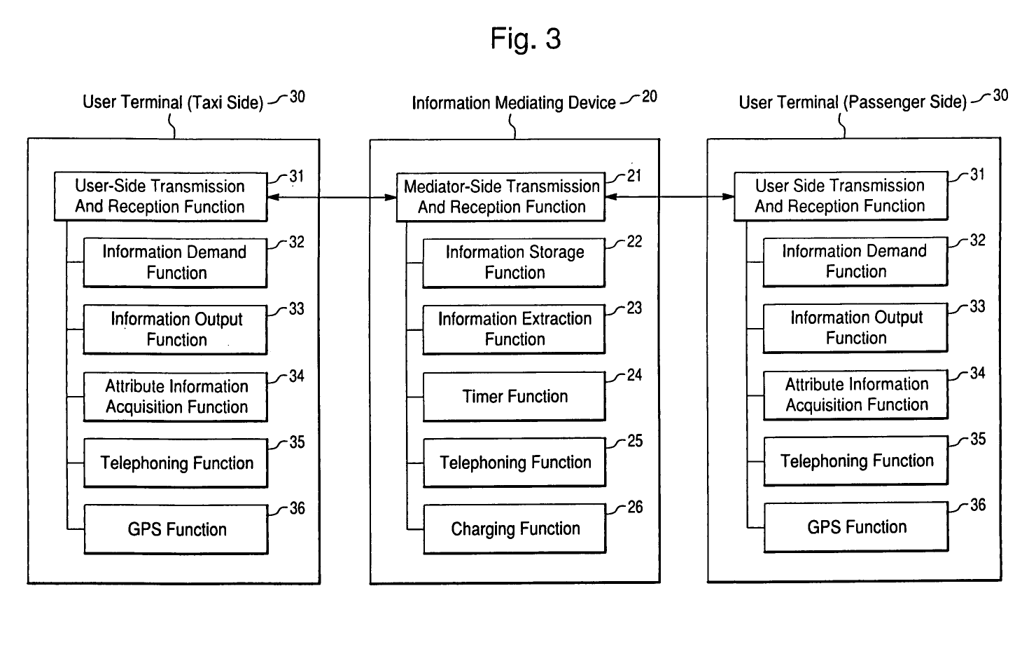

Subsequently, functions of an embodiment of the invention will be described in each block with reference to FIG. 3. In an operation service information mediating system according to an embodiment of the invention, user terminals 30, 30 possessed by passengers and taxis, respectively, are coupled to the information mediating device 20, which acquires information through a mediator via a communication network. The passengers and taxis may possess the same user terminals 30 for convenience' sake, but the present invention is not limited, and separate user terminals may be used provided that they have the necessary functions.

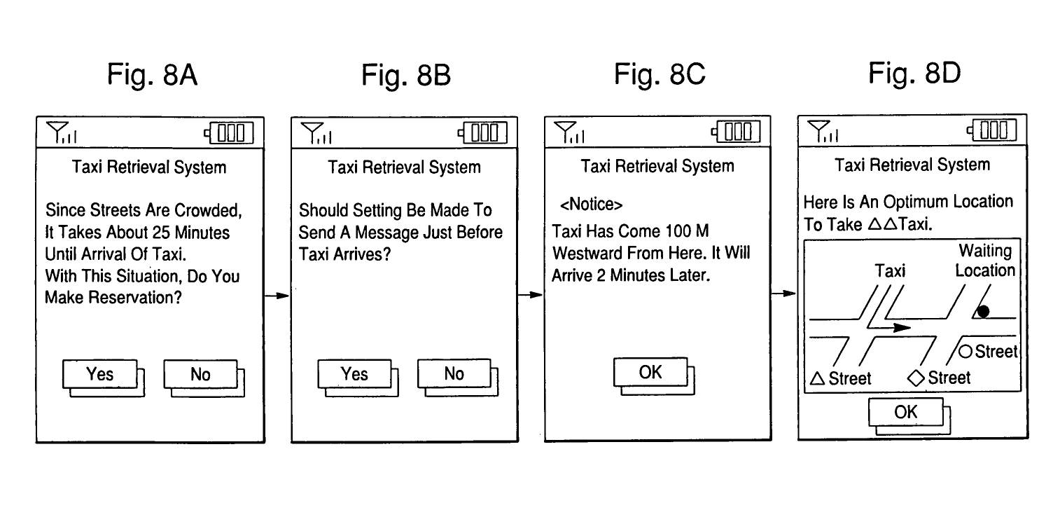

A description of the information mediating device 20 is now provided. A mediator-side transmission and reception function 21 may be a communication function via the Internet, or a communication function by direct telephone lines, for example. The mediator-side transmission and reception function 21 communicates with the user terminals 30 described below. An information storage function 22 stores passenger information and taxi information as users. That is, the storage function 22 functions as a database. An information extraction function 23 extracts a taxi or a passenger from taxi information, or passenger information accumulated in the information storage function 22 on the basis of a taxi selection condition input by a passenger, or a passenger selection condition input by a taxi. The taxi selection condition input by a passenger may include pick-up location information (where the passenger is picked up), car-type information, pick-up time information, presentable service information (the services presented by the taxi), driver's characteristic information, or the like, desired by a passenger who waits for a taxi. The pick-up location information may include information such as the “vicinity of Tokyo Station,” “Haneda Airport,” or the like. The car-type information may include a designation such as full-sized car, medium size car, or the like. The pick-up time information may include a designation of time, for example, 10 o'clock, 18 o'clock, or the like. The presentable service information may include information, such as, for example, pets allowable, nursing service available, or the like. Also, the driver's characteristic information may include information, such as, for example, sign language available, English speaking possible, or the like. In addition, this information may be stored after being subjected to language processing of each entry in user terminals with the use of existing techniques, on the basis of which information may be extracted. Alternatively, a predetermined list for setting of conditions may be set beforehand at the user terminals 30 to allow a user to make a selection from the list. For the sake of simplification of the processing, the latter measures are preferred. An example of the display is illustrated in FIG. 8 described below.

A timer function 24 sends information updated at predetermined time intervals periodically to passengers and taxis as users. Thereby, information satisfying a condition can be sequentially sent to the user terminals 30 after a lapse of time even in the case where the condition is not satisfied at a certain point of time, so that efficient information retrieval is made possible.

A telephoning function 25 enables both parties to telephone by Internet telephone in the case where the user terminals 30 are connected together via the Internet. This function enables telephoning by storing Internet provider (IP) numbers of both parties and designating the IP numbers for connection.

A charging function 26 charges a service fee based on the operation service information mediation according to the invention. For example, certain amounts of money may be charged to a passenger and a taxi, respectively, or to only one of the passenger and taxi. Further, an information mediation fee may be received from one of the passenger and taxi, and a utilization expediting fee may be conversely paid to the other of the two. That is, when a difference between the fees makes an information mediation business as an information mediation fee payable, such charging should be understood as a conception containing plus and minus charging.

The user terminals 30 will be described below. A user-side transmission and reception function 31 is of the same kind as that of the mediator-side transmission and reception function 21 of the information mediating device. An information demand function 32 inputs a taxi selection condition on a passenger side to select what taxi is requested, and inputs a passenger selection condition on a taxi side. In one configuration, in which a user makes a selection from a specific selection menu, the processing in the information mediating device 20 may be simply made. Systems other than ones including a selection menu system are also possible, provided that a condition input in existing language processings is understandable.

An information output function 33 provides a display screen in the case where, for example, portable telephones and PDA (Personal Digital Assistance) are utilized. In addition, it is possible to output information using only voice. An attribute information acquisition function 34 acquires attribute information of a taxi. Specific means for acquiring information includes means, in which information is acquired by input from a taxi driver, and means in which information is automatically acquired by a system. For example, position information of a taxi acquired by GPS is an example of a means in which information is automatically acquired by a system.

A telephoning function 35 may be, for example, a telephoning function of portable telephone, or a telephoning function of an Internet telephone. Also, a GPS function 36 may be, for example, a GPS receiver in a portable telephone with a GPS function. User terminals with such a function enable automatic detection of a present location of a user or taxi to send the information to the information mediating device 20.

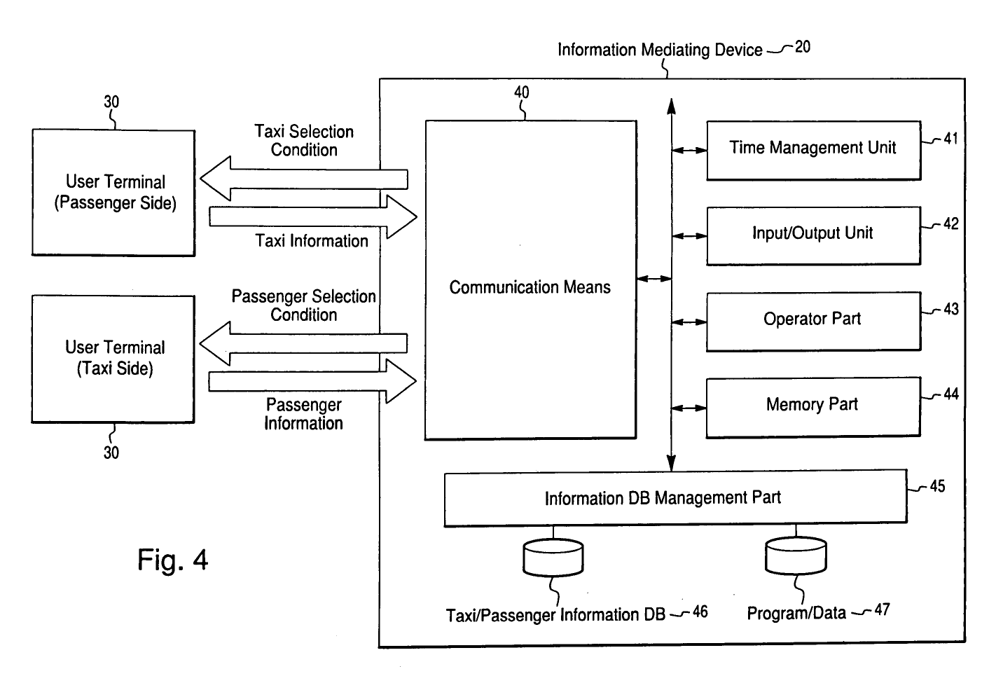

Subsequently, a hardware configuration of the information mediating device of an embodiment of the invention will be described with reference to FIG. 4. Communication unit 40 is one, through which the device receives and sends information to outside the device 20, such as to the user terminals 30, for example, and sends and receives information, such as taxi information or passenger information, between the communication unit 40 and the user terminals 30. Also, it is possible to communicate with other equipment via the communication unit 40. Specifically, the communication unit may perform communication by Internet, short-distance radio communication, communication by portable telephones, or the like, provided that the information is correctly transferred. A time management unit 41 includes the timer function. An input/output unit 42 presents information acquired by the device, set information, or the like to an operator in an understandable form, and accepts input from the operator. Any form of information is appropriate provided that information can be transferred between the operator and the unit. Specific examples of an output unit of the input/output unit 42 include liquid crystal displays for displaying characters and picture information, LEDs indicative of the status of equipment, speakers for outputting sound, and so on. Specific examples of an input unit of the input/output unit 42 include keyboards, mice, CD-ROM drives, knobs for volume control or the like.

An operator portion 43 is a portion providing an operation function for driving and processing respective functions (by implementing a program). Generally, the operator portion is composed of a CPU (central processing unit). A memory portion 44 is a portion of an execution area (and may include memory elements such as RAM, ROM), in which the operator portion 43 executes a program. The memory portion stores setting information of the present device and information acquired by communication. The memory portion 44 provides storage for storing various information. An information DB management portion 45 is a portion having a function for managing various data organization and data materialization functions. A taxi/passenger information DB 46 is a database for accumulating taxi information and passenger information. The database is updated based on the demands of passengers, or periodically in accordance with situations of taxis, and information is output in response to demands of passengers. Program/data unit 47 comprises programs for allowing the present hardware to function, and a data group. The program/data unit contains not only an OS (operating system) and set information, but also application software and data accompanying the same. The data may also include voice and picture information.

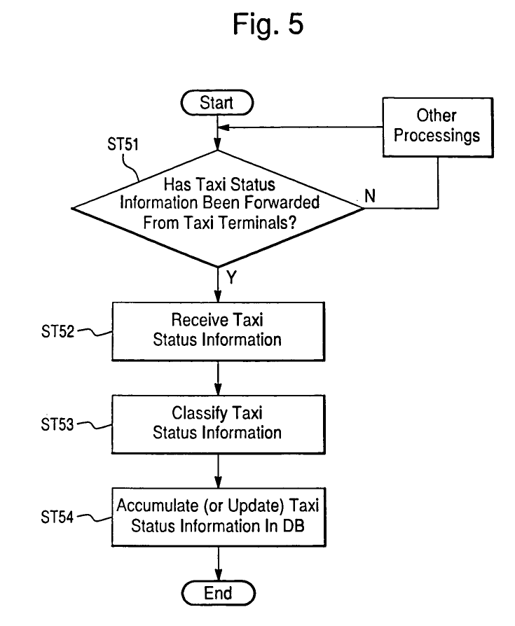

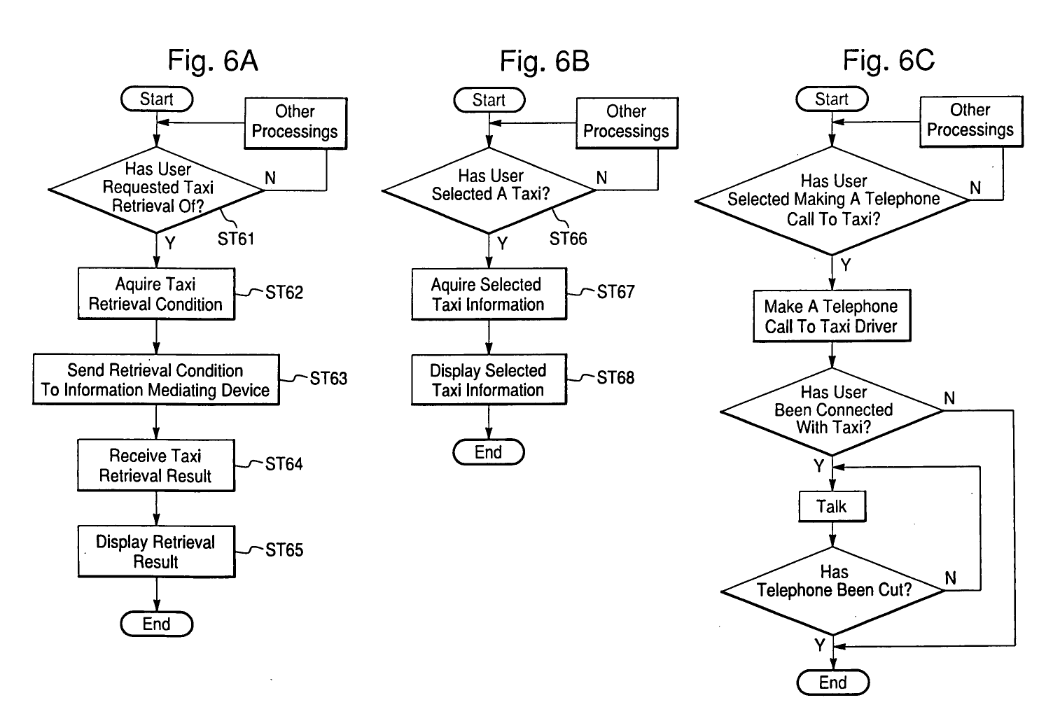

Subsequently, an operation of the operation service information mediation system according to an embodiment of the invention will be described with reference to flowcharts shown in FIGS. 5 and 6. First, FIG. 5 illustrates a flowchart where the information mediating device 20 collects information from the user terminals 30 on a taxi side. The flowchart comprises steps, in which a taxi sets a present situation of the taxi in the information mediating device in the case where the taxi is beginning, for example, a first service on that day. First, whether or not taxi status information has been forwarded from the taxi terminals is checked on the information mediating device side (step ST51), and when such information is forwarded, it is received (step ST52). The information is classified on the information mediating device side (step ST53), and the taxi information is accumulated (or updated) in the DB (step ST54). In addition, in the case where a taxi retrieves a passenger and a condition is not satisfied, the condition is updated as taxi information in the database for a specific period of time, and waits for retrieval with respect to whether it agrees with a taxi selection condition from a passenger. In FIG. 5 Y is used to mean “YES”, and N is used to mean “NO”.

A flowchart where a passenger terminal begins retrieval of a taxi will be described with reference to FIG. 6A. The flowchart illustrates the specific case where a passenger retrieves a taxi. The invention is not limited to this specific case, however, as described above and covers the case where a taxi retrieves a passenger, and this latter case can be processed in the same or similar steps and so an explanation therefor is omitted.

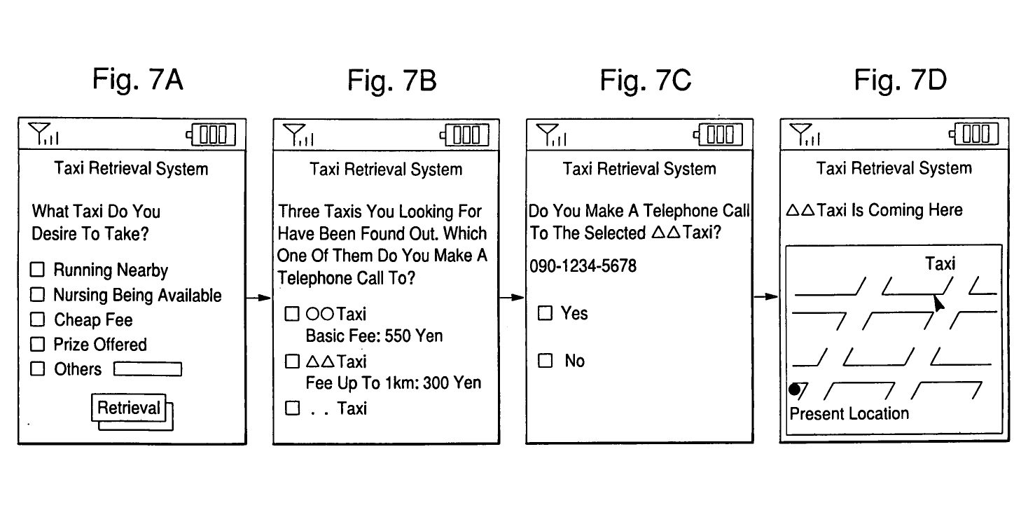

First, whether a user has demanded retrieval of a taxi is checked (step ST61), and the taxi retrieval condition is acquired (step ST62). Such retrieval condition is one shown in, for example, FIG. 7A described below. And the retrieval condition is sent to the information mediating device (step ST63), in which a taxi satisfying the condition is retrieved from the taxi/passenger information DB 46 shown in FIG. 4. In this case, the case where all the retrieval conditions are satisfied may be extracted, and extraction may be made provided that priority or weight is given to every condition and at least a specific agreement is present. For example, even in the case where a condition for a pick-up location is satisfied and other conditions are not satisfied, extraction may be made to impart flexibility to the system. Thereafter, the results of taxi retrieval are received as a list on a passenger side (step ST64), and the results of retrieval are displayed (step ST65). Thereby, a passenger can obtain information about a taxi which satisfies the taxi retrieval conditions of the passenger, or nearly does so. Thereafter, as shown in FIG. 6B a user may select a taxi from the list (step ST66), acquire information of the selected taxi (step ST67), and display the information (step ST68). The taxi information displayed may contain a telephone number and contact address, or the like, a user may directly contact the selected taxi by portable telephone, or the like. The user may communicate via an Internet telephone housed in the information mediating device 20 according to an embodiment of the invention. In addition, a user may optionally communicate by a message via the information mediating device 20. FIG. 6C. illustrates steps in the case where an Internet telephone is used.

Subsequently, FIGS. 7A-7D and 8A-8D illustrate examples of a display screen on the user terminal 30 in the case where a passenger retrieves a taxi. In FIGS. 7A-7D, there is shown and described a first example of a screen displayed on a user terminal when a passenger makes use of the present system to retrieve a taxi. In this example, a portable telephone having access to the Internet is provided as an example of a user terminal. First, FIG. 7A. illustrates a screen when a passenger selects a desired taxi. A passenger selects a desired service among several choices (selection of a plurality of choices is also possible) such as “traveling nearby”, “nursing being possible”, and depresses a retrieval button to retrieve taxi information. The choices can assume all services, which taxis can present, except ones shown in the figure.

Subsequently, FIG. 7B illustrates a screen where results of retrieval in FIG. 7A are sent to a passenger's portable telephone. Here, there is provided the case where “cheap fee” is selected and a taxi is retrieved. Further, a passenger can select a taxi desired to be taken, among such taxis satisfying the condition “cheap fee.”

FIG. 7C illustrates a screen where one taxi is selected among several taxis displayed in FIG. 7B. A driver's telephone number of a selected taxi is displayed, and it is prompted whether a telephone call should be made to make reservation. When a passenger selects “making a telephone call”, a telephone call can be made to the taxi selected. Finally, FIG. 7D illustrates a screen in the case where GPS is used to display a present location of a passenger and a present location of a taxi. Thereby, it is possible to determine a distance between the taxi and passenger, the positional relationship, an approximate time for the taxi to pick up the passenger, and so on.

In FIGS. 8A-8D, there is illustrated and described a second example of a screen displayed on a user terminal after a taxi is retrieved. First, FIG. 8A illustrates a message in the case where a passenger retrieves a taxi and designates a desired taxi, and there is time until the arrival of the taxi. Information such as the estimated necessary time until the arrival of the taxi or cause for delay of the taxi, is displayed, and other material which allows the passenger to determine whether a reservation should be made, is provided. Subsequently, FIG. 8B illustrates a message prompting the passenger to confirm whether a message should be sent when the taxi arrives nearby in the case where it is decided to reserve the taxi. Here, in the case where “YES” is selected, a message is sent to a passenger's portable telephone when the taxi arrives, and the passenger is informed of the arrival of the taxi.

FIG. 8C illustrates a screen, in which it is informed not by a message but by an application that the taxi approaches. In this case, the screen displays a distance to the taxi, direction, and estimated time until arrival, and informs the passenger of how many minutes the desired taxi takes until arrival. Notice of the taxi can be provided not only by a screen display but also by voice. FIG. 8D illustrates a screen indicating a route, along which the taxi travels to a passenger's location and informing the passenger of an appropriate waiting location. It is conceivable that if just the intersection for waiting is provided, the passenger may not understand which corner of the intersection the passenger should wait at. In order to avoid such a situation, the passenger is given an appropriate corner location and so can surely and efficiently meet the taxi. Also, a desired taxi can be readily looked for by making the present service open to members and customizing a configuration of a screen for each passenger.

In addition, an ID number sent to a taxi by a passenger can be displayed in a visible taxi compartment so as to readily enable the identification of each other in a crowded location such as a busy street. Thereby, even when there are many taxis at the location, a taxi called by a passenger can be clearly discriminated by outward appearance. For example, when a passenger inputs a four figure number into a screen of a portable telephone, the same number may be displayed on the taxi desired. The passenger can then surely identify the taxi with the displayed number. Also, when short-distance communication is used, such as routeuse, it is possible to detect that a taxi and a passenger are positioned nearby and to perform an operation, such as moving panels of various colors, so as to make it easy for the passenger to notice the taxi. Thereby, it is possible to make it easy for a passenger to locate a desired taxi among a plurality of taxis.

As described above, the utilization of the system according to embodiments of the invention makes it possible to surely reserve a taxi, which provides a desired service. That is, it is possible to display a list of taxis available to passengers, select a taxi, which provides a service desired by a passenger, and to retrieve a present location and a service presented by the taxi. It is also possible to make a telephone call to the taxi to instruct the taxi to come to a passenger's location.

Also, on the other hand, when an empty taxi looks for a subsequent passenger, retrieval with, for example, a passenger selection condition as a location where a previous passenger gets off is possible, whereby it is possible to efficiently retrieve a subsequent passenger without wasteful traveling.

Moreover, a passenger can make a telephone call directly to a taxi driver and ensure meeting the taxi by being able to communicate with the taxi until the passenger is picked up by the taxi. Also, by using position detection means such as GPS, a taxi and a passenger can ascertain present location of each other even in a location which is crowded making it difficult for both parties to locate each other, and even for a location for which it is difficult to give good directions. By using direct communication and position detection means in combination, it becomes possible to confirm a correct location, the appearance of both parties, the surrounding scene, and the like to prevent loss of a chance for a passenger to take a taxi.

What is claimed is:

1. An operation service information mediation system comprising:
a group of user terminals possessed by a group of passengers and a group of taxis, respectively, each user terminal having a transmission and reception function via a communication network; and
an information mediating device of an information mediator for mediating operation service information between the group of passengers and the group of taxis, the information mediating device of the information mediator comprising:
an information storage portion, in which taxi information from a group of taxis waiting for passengers, or passenger information from a group of passengers waiting for taxis is stored,
an information retrieval portion for retrieving specific taxi information, which satisfies a taxi selection condition received from a specific passenger, or specific passenger information, which satisfies a passenger selection condition received from a specific taxi, among the stored taxi information, or the stored passenger information, and
an information distribution portion for distributing the retrieved specific taxi information, or the retrieved specific passenger information to the specific passenger, or the specific taxi, respectively, via the network.

2. The operation service information mediation system according to claim 1, wherein the taxi selection condition received from the specific passenger contains at least one of pick-up location information, car-type information, pick-up time information, presentable service information, and driver's characteristic information, desired by a passenger who waits for a taxi.

3. The operation service information mediation system according to claim 2, wherein when the passenger cannot extract specific taxi information which satisfies the taxi selection condition, the taxi selection condition is stored, as the passenger information, together with information of a contact address designated by the passenger.

4. The operation service information mediation system according to claim 1, wherein the passenger selection condition received from the specific taxi contains at least one of pick-up location information, car-type information, pick-up time information, presentable service information, and driver's characteristic information.

5. The operation service information mediation system according to claim 4, wherein when the taxi cannot extract specific passenger information, which satisfies the passenger selection condition, the passenger selection condition is stored, as the taxi information, together with information of a contact address designated by the taxi and information of a present location of the taxi.

6. The operation service information mediation system according to claim 1, wherein the information mediating device of the information mediator further comprises:
a timer portion for periodic distribution of the extracted specific taxi information, or the extracted specific passenger information to the group of user terminals possessed by the group of passengers and the group of taxis, respectively.

7. The operation service information mediation system according to claim 1, wherein the information mediating device of the information mediator further comprises:
a charging function for charging an information delivery fee on a specific passenger having received the specific taxi information, or a specific taxi having received the specific passenger information, or both of the passenger and the taxi.

8. The operation service information mediation system according to claim 1, wherein the information mediating device of the information mediator further comprises:
a communication portion, by which both a specific passenger having received the specific taxi information and a specific taxi having received the specific passenger information are enabled to telephone each other via the Internet.

9. The operation service information mediation system according to claim 1, wherein a specific taxi having received the passenger information has a car specifying function for displaying an ID specific to the specific passenger, the car specifying function being configured such that the passenger may visually recognize the ID displayed in the car specifying function, or a predetermined signal is sent to the passenger when the taxi approaches the passenger at a predetermined distance, whereby the passenger can confirm the specific taxi mediated by the information mediating device.

10. The operation service information mediation system according to claim 9, wherein the car specifying function comprises a light sign display board.

11. An information mediating device of an information mediator for mediating operation service information among a group of user terminals, each terminal having a transmission and reception function via a communication network, the group of user terminals possessed by a group of passengers and a group of taxis, respectively, comprising:
an information storage portion, in which taxi information from a group of taxis waiting for passengers, or passenger information from a group of passengers waiting for taxis is stored,
an information retrieval portion for retrieving specific taxi information, which satisfies a taxi selection condition received from a specific passenger, or specific passenger information, which satisfies a passenger selection condition received from a specific taxi, among the stored taxi information, or the stored passenger information, and
an information distribution portion for distributing the retrieved specific taxi information, or the retrieved specific passenger information to the specific passenger, or the specific taxi via the network.

12. A user terminal comprising:
a connection to an information mediating device through communication lines to obtain operation service information and capable of retrieving specific taxi information, which satisfies a taxi selection condition designated by a passenger, or specific passenger information, which satisfies a passenger selection condition designated by a taxi.

13. The user terminal according to claim 12, further capable of automatically or manually forwarding information of a present location of the taxi or passenger to the information mediating device.

14. An operation service information mediating method of mediating to passengers, operation service information among a group of user terminals, each terminal having a transmission and reception function via a communication network, the group of user terminals possessed by a group of passengers and a group of taxis, the method comprising the steps of:
receiving a taxi selection condition from a specific passenger;
retrieving specific taxi information, which satisfies the taxi selection condition, from among stored taxi information, and storing the taxi selection condition from the specific passenger as passenger information together with contact address information designated by the passenger when the specific taxi information cannot be extracted from among the stored taxi information, and repeating the retrieval for a predetermined period of time, and
distributing results of the retrieval to the specific passenger via the network.

15. An operation service information mediating method of mediating to taxis, operation service information among a group of user terminals, each terminal having a transmission and reception function via a communication network the group of terminals possessed by a group of passengers and a group of taxis, respectively, the method comprising the steps of:
receiving a passenger selection condition from a specific taxi,
retrieving specific passenger information, which satisfies the passenger selection condition, from among stored passenger information, and storing the passenger selection condition from the specific taxi as taxi information together with contact address information designated by the taxi when the specific passenger information cannot be extracted from among the stored passenger information, and repeating the retrieval for a predetermined period of time, and
distributing results of the retrieval to the specific taxi via the network.
